(19) United States
(12) Patent Application Publication
(10) Pub. No.: US 2025/0304044 A1
(43) Pub. Date: Oct. 2, 2025

(54) VEHICLE CONTROL METHOD, VEHICLE CONTROL DEVICE, AND STORAGE MEDIUM

(71) Applicant: HONDA MOTOR CO., LTD., Tokyo (JP)

(72) Inventor: Yoshihiro Oniwa, Tokyo (JP)

(21) Appl. No.: 19/059,603

(22) Filed: Feb. 21, 2025

(30) Foreign Application Priority Data
Mar. 28, 2024 (JP) 2024-053791

(51) Int. Cl. B60W 30/09; B60W 30/12

(52) U.S. Cl. CPC B60W 30/09; B60W 30/12; B60W 2520/10; B60W 2540/18; B60W 2552/10; B60W 2710/207; B60W 2720/10

(57) ABSTRACT

A vehicle control method of an embodiment includes recognizing, by a computer, a surrounding situation of a vehicle, detecting, by the computer, a steering state of an occupant, executing, by the computer, avoidance steering assistance so that the vehicle travels along an avoidance target trajectory for avoiding an obstacle when it is determined that the vehicle is likely to come into collision with the obstacle on the basis of the recognized surrounding situation of the vehicle, and suppressing, by the computer, the avoidance steering assistance for the avoidance target trajectory when a steering operation of the occupant has been detected while the avoidance steering assistance is being executed.

### CROSS-REFERENCE TO RELATED APPLICATION

Priority is claimed on Japanese Patent Application No. 2024-053791, filed Mar. 28, 2024, the content of which is incorporated herein by reference.

### BACKGROUND

### Field of the Invention

The present invention relates to a vehicle control method, a vehicle control device, and a storage medium.

### Description of Related Art

In recent years, efforts to provide access to sustainable transportation systems that take into account vulnerable groups among traffic participants have become active. For this realization, research and development aims to further improve traffic safety and convenience through research and development relating to preventive safety technology.

In relation to this, in recent years, technology for generating a plurality of collision avoidance trajectories for avoiding a collision of a host vehicle with an obstacle, selecting a collision avoidance trajectory corresponding to the driver's operation of the host vehicle from among the plurality of collision avoidance trajectories, and controlling the traveling of the host vehicle on the basis of the selected collision avoidance trajectory has been disclosed (e.g., Japanese Unexamined Patent Application, First Publication No. 2013-79068).

### SUMMARY

Meanwhile, in preventive safety technology, in relation to steering control for avoiding an obstacle, a steering angle of a vehicle is adjusted to control the vehicle so that the vehicle reaches the avoidance trajectory when the steering of the occupant is insufficient for the avoidance trajectory and the steering angle of the host vehicle is controlled so that the vehicle returns to the avoidance trajectory when the steering of the occupant causes the behavior of the vehicle to exceed the avoidance trajectory. Therefore, there is a problem that the steering operation of the occupant may not be appropriately reflected in the behavior of the vehicle.

The present invention has been made in consideration of such circumstances, and an objective of the present invention is to provide a vehicle control method, a vehicle control device, and a storage medium for enabling the steering of an occupant to be appropriately reflected in behavior of a vehicle in accordance with a situation of the vehicle. By extension, the present invention can contribute to the development of a sustainable transportation system.

A vehicle control method, a vehicle control device, and a storage medium according to the present invention adopt the following configurations.

(1): According to an aspect of the present invention, there is provided a vehicle control method including: recognizing, by a computer, a surrounding situation of a vehicle; detecting, by the computer, a steering state of an occupant; executing, by the computer, avoidance steering assistance so that the vehicle travels along an avoidance target trajectory for avoiding an obstacle when it is determined that the vehicle is likely to come into collision with the obstacle on the basis of the recognized surrounding situation of the vehicle; and suppressing, by the computer, the avoidance steering assistance for the avoidance target trajectory when a steering operation of the occupant has been detected while the avoidance steering assistance is being executed.

(2): In the vehicle control method according to the above-described aspect (1), feedback control for a steering angle of the vehicle is executed so that the vehicle travels along the avoidance target trajectory on the basis of the avoidance target trajectory and a position of the vehicle, and the avoidance steering assistance during the execution is suppressed by deriving a first correction value according to a steering amount included in the detected steering state of the occupant and adjusting the steering angle in accordance with the derived first correction value in the execution of the feedback control.

(3): In the vehicle control method according to the above-described aspect (2), lane-keeping steering assistance for performing the feedback control for the steering angle of the vehicle is provided so that the vehicle travels along a lane-keeping target trajectory for suppressing a departure of the vehicle from a travel lane on the basis of the lane-keeping target trajectory and a position of the vehicle, the lane-keeping steering assistance during the execution is suppressed by deriving a second correction value according to a steering amount included in the detected steering state of the occupant and adjusting the steering angle in accordance with the derived second correction value in the execution of the feedback control, and the first correction value is larger than the second correction value.

(4): In the vehicle control method according to the above-described aspect (3), the first correction value and the second correction value are derived on the basis of the steering amount and a speed of the vehicle, and an adjustment is made so that the speed of the vehicle increases to a predetermined speed in accordance with an increase in the speed and decreases after exceeding the predetermined speed.

(5): In the vehicle control method according to the above-described aspect (1), the avoidance steering assistance is provided to generate the avoidance target trajectory so that the vehicle does not depart from an adjacent lane after the vehicle moves from a current travel lane to the adjacent lane so that a collision with the obstacle is avoided.

(6): According to another aspect of the present invention, there is provided a vehicle control device including: a recognizer configured to recognize a surrounding situation of a vehicle; a steering state detector configured to detect a steering state of an occupant; and a steering controller configured to execute avoidance steering assistance so that the vehicle travels along an avoidance target trajectory for avoiding an obstacle when it is determined that the vehicle is likely to come into collision with the obstacle on the basis of the surrounding situation of the vehicle recognized by the recognizer, wherein the steering controller suppresses the avoidance steering assistance for the avoidance target trajectory when a steering operation of the occupant has been detected while the avoidance steering assistance is being executed.

(7): According to yet another aspect of the present invention, there is provided a computer-readable non-transitory storing medium storing a program for causing a computer to recognize a surrounding situation of a vehicle; detect a steering state of an occupant of the vehicle; execute avoidance steering assistance so that the vehicle travels along an avoidance target trajectory for avoiding an obstacle when it is determined that the vehicle is likely to come into collision with the obstacle on the basis of the recognized surrounding situation of the vehicle; and suppress the avoidance steering assistance for the avoidance target trajectory when a steering operation of the occupant has been detected while the avoidance steering assistance is being executed.

According to the above-described aspects (1) to (7), it is possible to appropriately reflect steering of an occupant in behavior of a vehicle in accordance with a situation of the vehicle.

### BRIEF DESCRIPTION OF THE DRAWINGS

FIG. 1 is a configuration diagram of a vehicle on which a vehicle control device according to an embodiment is mounted.

FIG. 2 is a functional configuration diagram of a driving state detector.

FIG. 3 is a functional configuration diagram of a vehicle controller.

FIG. 4 is an explanatory diagram of the content of vehicle control relating to collision avoidance.

FIG. 5 is an explanatory diagram of the content of alert control.

FIG. 6 is an explanatory diagram of the content of collision alert control.

FIG. 7 is an explanatory diagram of the content of automated steering avoidance control.

FIG. 8 is an explanatory diagram of steering control after a driver-specific steering trigger.

FIG. 9 is an explanatory diagram of a steering control process executed by a steering controller.

FIG. 10 is a diagram showing a relationship between a driver's steering amount and a steering angle.

FIG. 11 is an explanatory diagram of the derivation of a correction value.

FIG. 12 is a flowchart showing an example of a process executed by a driving assistance device according to an embodiment.

### DESCRIPTION OF EMBODIMENTS

Hereinafter, embodiments of a vehicle control method, a vehicle control device, and a storage medium of the present invention will be described with reference to the drawings.

### Overall Configuration

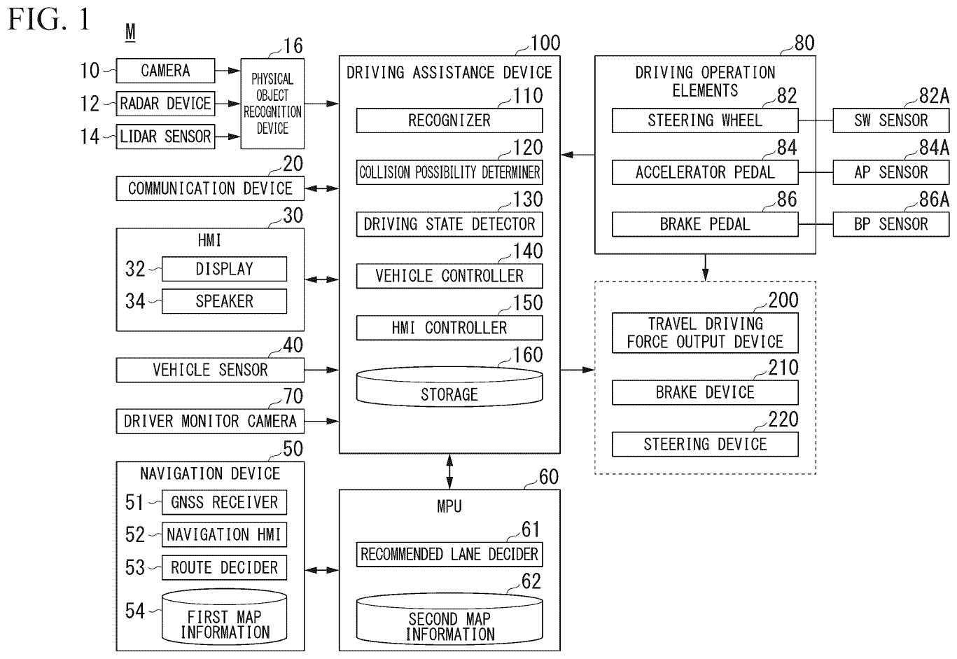

FIG. 1 is a configuration diagram of a vehicle on which the vehicle control device according to an embodiment is mounted. The vehicle (hereinafter, a host vehicle M) on which the vehicle control device is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power when a secondary battery or a fuel cell is discharged.

For example, the host vehicle M includes a camera 10, a radar device 12, a light detection and ranging (LIDAR) sensor 14, a physical object recognition device 16, a communication device 20, a human machine interface (HMI) 30, a vehicle sensor 40, a navigation device 50, a map positioning unit (MPU) 60, a driver monitor camera 70, a driving operation element 80, a driving assistance device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example and some of the constituent elements may be omitted or other constituent elements may be further added. The driving assistance device 100 is an example of a “vehicle control device.”

For example, the camera 10 is a digital camera using a solid-state imaging element such as a charge-coupled device (CCD) or a complementary metal oxide semiconductor (CMOS). The camera 10 is attached to any location on the host vehicle M. When the view in front of the host vehicle M is imaged, the camera 10 is attached to an upper part of a front windshield, a rear surface of a rearview mirror, or the like. For example, the camera 10 periodically and iteratively images the surroundings of the host vehicle M. The camera 10 may be a stereo camera.

The radar device 12 radiates radio waves such as millimeter waves around the host vehicle M and detects at least a position of a physical object (a distance to and a direction of the physical object) by detecting radio waves (reflected waves) reflected by the physical object. The radar device 12 is attached to any location on the host vehicle M. The radar device 12 may detect a position and a speed of the physical object in a frequency-modulated continuous wave (FM-CW) scheme.

The LIDAR sensor 14 radiates light to the vicinity of the host vehicle M (or electromagnetic waves having a wavelength close to that of light) and measures scattered light. The LIDAR sensor 14 detects a distance from an object on the basis of time from light emission to light reception. The radiated light is, for example, pulsed laser light. The LIDAR sensor 14 is attached to any location on the host vehicle M.

The physical object recognition device 16 performs a sensor fusion process on detection results from some or all of the camera 10, the radar device 12, and the LIDAR sensor 14 to recognize a position, a type, a speed, and the like of a physical object. The physical object recognition device 16 outputs recognition results to the driving assistance device 100. The physical object recognition device 16 may output detection results of the camera 10, the radar device 12, and the LIDAR sensor 14 to the driving assistance device 100 as they are. The physical object recognition device 16 may be omitted from the host vehicle M. Some or all of the camera 10, the radar device 12, the LIDAR sensor 14, and the physical object recognition device 16 are examples of an “external environment detection device.”

The communication device 20 communicates with another vehicle located in the vicinity of the host vehicle M, using, for example, a cellular network or a Wi-Fi network, Bluetooth (registered trademark), dedicated short range communication (DSRC), or the like, or communicates with various types of server devices via a radio base station.

The HMI 30 presents various types of information to an occupant of the host vehicle M and receives an input operation from the occupant. The HMI 30 includes, for example, a display 32 and a speaker 34. The display 32 is, for example, a liquid crystal display (LCD) or an organic electro-luminescence (EL) display device. The display 32 displays various types of images (including a video) in the embodiment. The display 32 may be integrated with an input as a touch panel. The speaker 34 outputs a predetermined sound (e.g., an alert or the like). In addition to (or instead of) the display 32 and the speaker 34, the HMI 30 may include a microphone, a buzzer, a vibration generation device (vibrator), a touch panel, a switch, a key, or the like. The switch may include, for example, a changeover switch that switches between whether or not to provide a predetermined driving assistance in the driving assistance device 100.

The vehicle sensor 40 includes a speed sensor configured to detect the speed of the host vehicle M, an acceleration sensor configured to detect acceleration, a yaw rate sensor configured to detect a yaw rate (a rotational angular velocity around a vertical axis passing through a center of gravity of the host vehicle M), a steering angle sensor configured to detect a steering angle (an angle (an actual steering angle) of a steering wheel of the host vehicle M or a torque amount), a direction sensor configured to detect a direction of the host vehicle M, and the like. The vehicle sensor 40 may include a position sensor configured to detect a position of the host vehicle M. The position sensor is, for example, a sensor configured to acquire position information (longitude and latitude information) from a Global Positioning System (GPS) device. The position sensor may be a sensor configured to acquire position information using a global navigation satellite system (GNSS) receiver 51 of the navigation device 50.

For example, the navigation device 50 includes the GNSS receiver 51, a navigation HMI 52, and a route decider 53. The navigation device 50 stores first map information 54 in a storage device such as a hard disk drive (HDD) or a flash memory. The GNSS receiver 51 identifies a position of the host vehicle M on the basis of a signal received from a GNSS satellite. The position of the host vehicle M may be identified or complemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route decider 53 decides a route (hereinafter referred to as a route on a map) from the position of the host vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by the link. The first map information 54 may include curvature of a road, point of interest (POI) information, and the like. The route on the map is output to the MPU 60. The navigation device 50 may provide route guidance using the navigation HMI 52 on the basis of the route on the map. The navigation device 50 may be implemented, for example, according to a function of a terminal device such as a smartphone or a tablet terminal possessed by the occupant.

The navigation device 50 may transmit a current position and a destination to a navigation server via the communication device 20 and acquire a route equivalent to the route on the map from the navigation server.

For example, the MPU 60 includes a recommended lane decider 61 and stores second map information 62 in a storage device such as an HDD or a flash memory. The recommended lane decider 61 divides the route on the map provided from the navigation device 50 into a plurality of blocks (e.g., divides the route every 100 [m] in a travel direction of the vehicle), and decides a recommended lane for each block with reference to the second map information 62. The recommended lane decider 61 decides in what lane numbered from the left the vehicle will travel. The recommended lane decider 61 decides the recommended lane so that the host vehicle M can travel along a reasonable route for traveling to a branching destination when there is a branch point on the route on the map. The second map information 62 is map information with higher accuracy than the first map information 54. The second map information 62 includes, for example, information about a center of a lane, lane boundary information such as road markings for dividing lanes, and the like. The second map information 62 may include road information, traffic regulation information, address information (address/postal code), facility information, telephone number information, and the like. The second map information 62 may be updated at any time by the communication device 20 communicating with other devices. The first map information 54 and the second map information 62 may be stored in the driving assistance device 100.

The driver monitor camera 70 is, for example, a digital camera using a solid-state imaging element such as a CCD or a CMOS. The driver monitor camera 70 is attached to any location on the host vehicle M in a position and a direction where the head and the upper body (including a hand position) of the occupant (hereinafter, the driver) sitting in the driver's seat of the host vehicle M can be imaged from the front (in a direction in which his/her face is imaged). For example, the driver monitor camera 70 is attached to an upper part of a display device provided on the central portion of the instrument panel of the host vehicle M. For example, it is possible to determine whether the driver has been alerted to the surroundings of the host vehicle M (e.g., whether the driver's face is facing at least in the travel direction of the host vehicle M) on the basis of the direction of the driver's face included in the camera image captured by the driver monitor camera 70 (the direction of the face relative to an attachment position and an image capture direction of the driver monitor camera 70). Because the camera image includes the driver and the steering wheel 82, it is also possible to determine whether the driver is gripping the steering wheel 82 from the captured image. The driver monitor camera 70 images the cabin including the driver of the host vehicle M from an arrangement position at predetermined intervals and outputs a captured image to the driving assistance device 100.

The driving operation elements 80 include, for example, a steering wheel 82, an accelerator pedal 84, a brake pedal 86, a direction indicator operation switch, a shift lever, and other operation elements. A sensor that detects an amount of operation or the presence or absence of operation is attached to the driving operation element 80 and its detection result is output to the driving assistance device 100 or some or all of the travel driving force output device 200, the brake device 210, and the steering device 220.

For example, a steering wheel sensor (SW sensor) 82A is provided on the steering wheel 82. The SW sensor 82A detects whether the driver is gripping the steering wheel 82 using a contact sensor, a pressure sensor, or the like. The SW sensor 82A detects an amount of operation of the steering wheel 82 input (operated) by the driver (the driver's steering amount, a steering input torque, or a steer torque) and an operation speed (a steering angular velocity). The SW sensor 82A may also detect an operation change rate (a torque change rate). The steering wheel 82 does not necessarily have to be annular, and may be in the form of an irregular steering wheel, a joystick, a button, or the like. In this case, the SW sensor 82A detects an operation amount according to each form.

An accelerator pedal sensor (AP sensor) is attached to the accelerator pedal 84. An AP sensor 84A detects an operation amount (an opening degree) of the accelerator pedal 84 that changes with the driver's operation on the accelerator pedal 84. A brake pedal sensor (BP sensor) 86A is provided on a brake pedal 86. The BP sensor 86A detects an operation amount (an opening degree) of the brake pedal 86 that changes with an operation on the brake pedal 86 of the driver.

The travel driving force output device 200 outputs a travel driving force (torque) for enabling the traveling of the host vehicle M to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described constituent elements in accordance with information input from the driving assistance device 100 or information input from the driving operation element 80.

For example, the brake device 210 includes a brake caliper, a cylinder configured to transfer hydraulic pressure to the brake caliper, an electric motor configured to generate hydraulic pressure in the cylinder, and an ECU. The ECU controls the electric motor in accordance with the information input from the driving assistance device 100 or the information input from the driving operation element 80 so that brake torque according to a braking operation is output to each wheel. The brake device 210 may include a mechanism configured to transfer the hydraulic pressure generated according to an operation on the brake pedal included in the driving operation elements 80 to the cylinder via a master cylinder as a backup. Also, the brake device 210 is not limited to the above-described configuration and may be an electronically controlled hydraulic brake device configured to control an actuator in accordance with information input from the driving assistance device 100 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor in accordance with the information input from the driving assistance device 100 or the information input from the driving operation element 80 to change the direction of the steerable wheels.

### [Driving Assistance Device]

The driving assistance device 100 includes, for example, a recognizer 110, a collision possibility determiner 120, a driving state detector 130, a vehicle controller 140, an HMI controller 150, and a storage 160. The recognizer 110, the collision possibility determiner 120, the driving state detector 130, the vehicle controller 140, and the HMI controller 150 are implemented, for example, by a hardware processor such as a central processing unit (CPU) executing a program (software). Also, some or all of the above constituent elements may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be pre-stored in a storage device (a storage device including a non-transitory storage medium) such as an HDD or a flash memory of the driving assistance device 100 or may be stored in a removable storage medium such as a DVD or a CD-ROM and installed in an HDD or a flash memory of the driving assistance device 100 when the storage medium (the non-transitory storage medium) is mounted in a drive device. The HMI controller 150 is an example of a “notification controller.”

For example, settings are configured inside the travel driving force output device 200, the brake device 210, and the steering device 220 so that instructions from the driving assistance device 100 to the travel driving force output device 200, the brake device 210, and the steering device 220 are executed with priority over the detection results from the driving operation element 80. In relation to braking, if a braking force based on the operation amount of the brake pedal 86 is greater than in the instruction from the driving assistance device 100, the braking based on the operation amount may be set to be executed with priority. As a mechanism for executing the instruction from the driving assistance device 100 with priority, communication priority in the in-vehicle local area network (LAN) may be used. In relation to steering, a setting process may be performed so that a steering force based on the instruction from the driving assistance device 100 and a steering force based on the driver's operation amount of the steering wheel 82 may be added together for execution.

The storage 160 may be implemented by the various types of storage devices described above, a solid-state drive (SSD), an electrically erasable programmable read-only memory (EEPROM), a read-only memory (ROM), a random-access memory (RAM), or the like. The storage 160 stores, for example, a program (e.g., a vehicle control program), information used by constituent elements within the driving assistance device 100, other types of information, and the like. The storage 160 may store the above-described map information (the first map information 54 and the second map information 62).

On the basis of information input from the external environment detection device, the recognizer 110 recognizes a surrounding situation of the host vehicle M. For example, the recognizer 110 recognizes a state such as a position (a relative position and an inter-vehicle distance), a speed (a relative speed), or acceleration of a physical object located in a nearby area (e.g., within a predetermined distance from the host vehicle M). The physical object is, for example, another vehicle, a bicycle, a pedestrian, or the like. The position of the physical object, for example, is recognized as a position of an absolute coordinate system having a representative point of the host vehicle M (a center of gravity, a drive shaft center, or the like) as the origin, and is used for control. The position of the physical object may be represented by a representative point such as the center of gravity or a corner of the physical object or may be represented in a region. The “state” of the physical object may include the acceleration or jerk of the physical object, or the “action state” (e.g., whether or not the lane is changing or is about to change). The recognizer 110 recognizes a relative position or a relative speed with respect to the physical object.

Also, for example, the recognizer 110 recognizes a lane shape in which the host vehicle M is traveling (a travel lane). For example, the recognizer 110 recognizes a shape, a line type, and the like of a lane (a travel lane) where the host vehicle Mis traveling or and adjacent lane adjacent to the travel lane by comparing a pattern of road markings (e.g., an arrangement of solid lines and broken lines) obtained from the second map information 62 with a pattern of road markings in the vicinity of the host vehicle M recognized from an image captured by the camera 10. The recognizer 110 may recognize the travel lane and the adjacent lane by recognizing a runway boundary (road boundary) including a road marking, a shoulder, a curb, a median strip, a guardrail, and the like as well as a road marking. In this recognition, a position of the host vehicle M acquired from the navigation device 50 or a processing result of the INS may be taken into account. The recognizer 110 recognizes a temporary stop line, an obstacle, red traffic light, a toll gate, and other road events from physical object recognition results. The obstacle is a physical object that the host vehicle M needs to avoid the collision, and includes, for example, another vehicle, a bicycle, a pedestrian, and the like.

When the travel lane is recognized, the recognizer 110 recognizes a position or an orientation of the host vehicle M with respect to the travel lane. For example, the recognizer 110 may recognize the deviation of a reference point of the host vehicle M from the center of the lane and an angle formed between the travel direction of the host vehicle M and a line connected to the center of the lane as a relative position and orientation of the host vehicle M related to the travel lane. Alternatively, the recognizer 110 may recognize a position of the reference point of the host vehicle M related to one side end portion (a road marking or a road boundary) of the travel lane or the like as a relative position of the host vehicle M related to the travel lane.

The collision possibility determiner 120 determines whether or not there is a possibility of a collision between the host vehicle M and an obstacle (e.g., another vehicle) on the basis of a surrounding situation (external environment information) recognized by the recognizer 110. For example, the collision possibility determiner 120 determines whether or not there is a possibility of a collision between the host vehicle M and another vehicle on the basis of a collision margin value for another vehicle (a preceding vehicle) located in front of the host vehicle M on the basis of the surrounding situation. The collision margin value is, for example, a value that is set on the basis of a time to collision TTC, but may also be a value that is set on the basis of time headway THW. The time to collision TTC is derived, for example, by dividing a relative distance by a relative speed in the relationship between the host vehicle M and the other vehicle. The time headway THW is derived, for example, by dividing the relative distance (the inter-vehicle distance) by the speed of the host vehicle M. The time to collision TTC may be derived using, for example, a trained model, a predetermined function, or the like in which the time to collision TTC is output if the positions and speeds of the host vehicle M and the other vehicle are input or may be derived using a correspondence table in which the relative speed and relative position are associated with the time to collision TTC. The above-described derivation method is also true for the time headway THW. For example, the shorter the time to collision TTC (or the time headway THW), the smaller the collision margin value (in other words, the longer the time to collision, the larger the collision margin value). For example, the collision possibility determiner 120 determines that there is a possibility that the host vehicle M and the other vehicle will come into collision with each other when the collision margin value is less than a threshold value and determines that there is no possibility of a collision when the collision margin value is equal to or greater than the threshold value. Hereinafter, description will be given using the time to collision TTC as an example of the collision margin value.

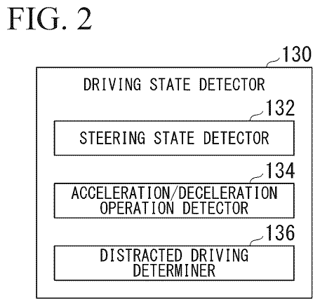

The driving state detector 130 detects a driving state of the occupant (the driver) of the host vehicle M. FIG. 2 is a functional configuration diagram of the driving state detector 130. The driving state detector 130 includes, for example, a steering state detector 132, an acceleration/deceleration operation detector 134, and a distracted driving determiner 136. The steering state detector 132 detects, for example, whether the steering wheel 82 is being gripped or information about an amount of operation (a driver's steering amount (steering input torque) or a steering torque change rate). The steering state detector 132 may include information about the driver's steering speed and steering angle speed (a speed until a predetermined steering angle amount is reached). The steering state detector 132 may detect a state in which the driver is not performing a steering operation. The steering state detector 132 performs the above-described detection process on the basis of, for example, detection results of the SW sensor 82A and the vehicle sensor 40, the driver's operation obtained from the camera image of the driver monitor camera 70, and the like.

The acceleration/deceleration operation detector 134 detects at least one of the driver's accelerator operation or operation amount (opening degree) of the accelerator pedal 84 and the brake operation or operation amount (opening degree) of the brake pedal 86. The acceleration/deceleration operation detector 134 may detect a state in which the driver is not operating the accelerator or brake. The acceleration/deceleration operation detector 134 performs the above-described detection processes on the basis of, for example, the detection results of the AP sensor 84A and the BP sensor 86A, the detection result of the vehicle sensor 40, and the like.

The distracted driving determiner 136 determines the distracted driving of the driver. The distracted driving is, for example, a state in which the driver's driving operation of the host vehicle M becomes slow (or no operation is performed) due to a decrease in the driver's attention or the like. For example, on the basis of the detection result of the SW sensor 82A, the distracted driving determiner 136 determines that the driver is in the distracted driving state when a state in which the driver's steering operation of the steering wheel 82 is less than a predetermined threshold value continues for a predetermined time or more and determines that the driver is not in the distracted driving state when the state does not continue for the predetermined time or more.

Instead of (or in addition to) the driver's steering operation, the distracted driving determiner 136 may determine that the driver is in the distracted driving state when a state in which the change in the opening degree of each of the accelerator pedal 84 and the brake pedal 86 is less than a threshold value continues for a predetermined time or more on the basis of the detection results of the AP sensor 84A and the BP sensor 86A. Instead of (or in addition to) the above-described determination, the driving state detector 130 may determine that the driver is in the distracted driving state when the state in which the driver's state is not suitable for driving is detected continues for a predetermined time or more and determines that the driver is not in the distracted driving state when the state does not continue for the predetermined time or more. For example, the distracted driving determiner 136 detects that the driver is not in a state suitable for driving when the driver is not monitoring the surroundings (particularly the front) of the host vehicle M due to looking away or the like or when it is predicted that the driver is not concentrating from a certain facial expression (a sleepy face, a face in pain) or the like on the basis of a result of analyzing an image captured by the driver monitor camera 70.

The above-described predetermined time may be a fixed time or a variable time. The predetermined time may be set, for example, in accordance with the time to collision TTC between the host vehicle M and an obstacle (e.g., a preceding vehicle) around the host vehicle M and the speed of the host vehicle M. Specifically, the predetermined time is set to be shorter as the speed of the host vehicle M increases and the predetermined time is set to be shorter as the time to collision TTC decreases. Thereby, the more appropriate determination of distracted driving can be made on the basis of the situation of the host vehicle M and the surrounding situation based on the speed of the host vehicle M and the positional relationship between the host vehicle M and the obstacle. The determination of distracted driving may be made comprehensively on the basis of the determination results based on the plurality of conditions described above.

The vehicle controller 140 controls one or both of the steering and acceleration/deceleration of the host vehicle M on the basis of the surrounding situation recognized by the recognizer 110, and provides driving assistance to the driver. For example, the vehicle controller 140 generates a future target trajectory so that the host vehicle M travels along a recommended lane decided by the MPU 60, and controls one or both of the steering and acceleration/deceleration of the host vehicle M on the basis of a surrounding situation so that the host vehicle M travels along the generated target trajectory. The vehicle controller 140 may control one or both of the steering and acceleration/deceleration of the host vehicle M on the basis of a processing result of at least one of the collision possibility determiner 120 and the driving state detector 130.

For example, when it is determined that the host vehicle M is likely to come into collision with an obstacle, the vehicle controller 140 generates an avoidance target trajectory for avoiding the collision and controls one or both of the steering and acceleration/deceleration of the host vehicle M so that the host vehicle M travels along the generated avoidance target trajectory. The vehicle controller 140 may perform control (override control) for stopping the vehicle control being executed and switching to manual driving by the driver in accordance with a predetermined driving operation of the driver during the vehicle control. Details of the process of the vehicle controller 140 will be described below.

The HMI controller 150 notifies occupants (including the driver) of predetermined information through the HMI 30. The predetermined information includes, for example, information about the traveling of the host vehicle M, such as information about the state of the host vehicle M and information about the driving assistance control. The information about the state of the host vehicle M includes, for example, a speed, engine speed, shift position, and the like of the host vehicle M. The information about the driving control includes, for example, a type of driving assistance control being executed (e.g., gradual deceleration control, centering steering control, collision avoidance braking control, collision avoidance steering control, or lane-keeping steering control), the reasons for the activation of the driving assistance control, a situation of the driving assistance control, and the like. The information about the driving assistance control may include information about an alert or a collision alert for the driver. The predetermined information may include information about a current position or destination of the host vehicle M, the remaining amount of fuel, and the like and may also include information unrelated to the driving control of the host vehicle M, such as television programs and content (e.g., movies) stored in a storage medium such as a DVD.

For example, the HMI controller 150 may generate an image including the above-described predetermined information and display the generated image on the display 32 of the HMI 30 or may generate a sound indicating the predetermined information and output the generated sound from the speaker 34 of the HMI 30. The timing at which the sound is output may be, for example, a timing at which driving control is started or stopped, a timing at which the image to be displayed is switched, a timing at which the host vehicle Mis in a predetermined state, or the like. The HMI controller 150 may output the information received by the HMI 30 to the vehicle controller 140 or the like.

### [Vehicle Controller]

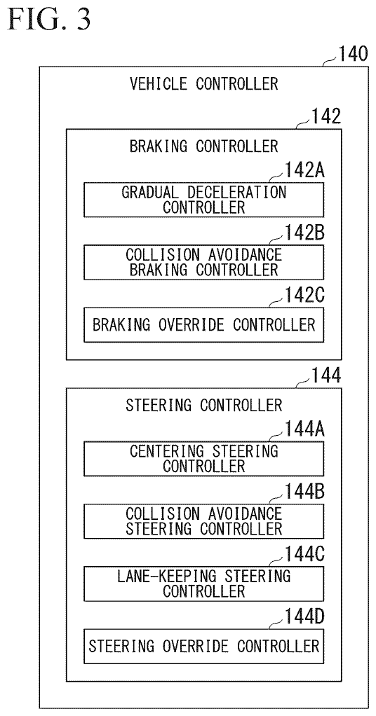

Next, details of the vehicle controller 140 will be described. FIG. 3 is a functional configuration diagram of the vehicle controller 140. The vehicle controller 140 includes, for example, a braking controller 142 and a steering controller 144. The vehicle controller 140 performs alert control and avoidance control for avoiding a collision between the host vehicle M and an obstacle according to the control of the braking controller 142 and the steering controller 144. The alert control is control that is activated when the host vehicle M approaches the obstacle, and includes, for example, gradual deceleration control and centering steering control, which will be described below. The avoidance control is control that is activated when the host vehicle M approaches the obstacle before the alert control is activated, and includes, for example, collision avoidance braking control and collision avoidance steering control, which will be described below. These control processes are examples of driving assistance control that assists the driver in driving.

When it is determined that an obstacle is located in front of the host vehicle M on the basis of a recognition result of the recognizer 110, the braking controller 142 performs braking control of the host vehicle M on the basis of target deceleration of the host vehicle M. For example, the braking controller 142 sets a deceleration state on the basis of the time to collision TTC between the host vehicle M and the obstacle and executes deceleration control based on the set deceleration state. The braking controller 142 includes, for example, a gradual deceleration controller 142A, a collision avoidance braking controller 142B, and a braking override controller 142C.

The gradual deceleration controller 142A performs gradual deceleration control of the host vehicle M when the recognizer 110 determines that an obstacle (e.g., another vehicle) is located in front of the host vehicle M. The gradual deceleration control is a control (alert control) process of notifying the driver that an obstacle is approaching according to the vehicle's behavior of deceleration (a change in longitudinal G) and alerts the driver to the obstacle, and is different from the collision avoidance control for avoiding the collision with the obstacle (in this regard, there may be cases where the collision with the obstacle is avoided as a result). For example, when it is determined that an obstacle is located in front of the host vehicle M, the gradual deceleration controller 142A derives target deceleration of the host vehicle M and decelerates the host vehicle M to approach the derived target independently of the driver's operation. For example, the gradual deceleration controller 142A generates a target trajectory including speed information and performs deceleration control of the host vehicle M so that the host vehicle M travels along the generated target trajectory. The gradual deceleration control may be executed when the driving state detector 130 detects that the driver is in the distracted driving state or may be executed when the collision margin value satisfies an operating condition of the gradual deceleration control.

The collision avoidance braking controller 142B performs emergency brake control for avoiding the collision between the host vehicle M and the obstacle. For example, when the collision possibility determiner 120 determines that there is a possibility that the host vehicle M will come into collision with the obstacle, the collision avoidance braking controller 142B performs braking control (deceleration control) for avoiding the collision. The braking control to be executed by the collision avoidance braking controller 142B includes, for example, collision mitigation brake system (CMBS) control for assisting in collision avoidance or damage mitigation. For example, the collision avoidance braking controller 142B generates a target trajectory including speed information and performs deceleration control of the host vehicle M so that the host vehicle M travels along the generated target trajectory. The braking control to be executed by the collision avoidance braking controller 142B may be executed, for example, after gradual deceleration control, or may be executed when the collision margin value satisfies the operating condition of the collision avoidance braking control.

The braking override controller 142C determines whether or not to perform override control (override determination) according to the driver's driving operation (the driver's operation) during the execution of the above-described braking control (gradual deceleration control or collision avoidance braking control). The driver operation used for the override determination during braking control is an accelerator operation or a brake operation. For example, during braking control, when an operation amount of the driver's accelerator operation (the operation amount of the accelerator pedal 84 detected by the AP sensor 84A) or an operation amount of the driver's brake operation (the operation amount of the brake pedal 86 detected by the BP sensor 86A) becomes equal to or greater than an override threshold value, it is determined to perform override control. When it is determined to perform override control, the braking override controller 142C stops the braking control being executed. In this way, it is possible to execute more appropriate override control (control for switching to manual driving by the driver) for the braking control by determining the driver's intention according to the accelerator operation or brake operation.

The steering controller 144 controls the steering of the host vehicle M. The steering controller 144 includes, for example, a centering steering controller 144A, a collision avoidance steering controller 144B, a lane-keeping steering controller 144C, and a steering override controller 144D.

When the recognizer 110 determines that an obstacle is located in front of the host vehicle M, the centering steering controller 144A generates a target trajectory for moving the host vehicle M toward the center of a travel lane and executes steering control (centering steering control) so that the host vehicle M travels along the generated target trajectory. This steering control is not for avoiding the collision with the obstacle but is for notifying the driver that an obstacle is approaching by the vehicle's behavior (a change in lateral G) of moving laterally near the center, and for prompting the driver to pay attention to the obstacle (in this regard, there may be cases where the collision with the obstacle is avoided as a result). This steering control allows the driver to notice the obstacle ahead at an early stage, thereby contributing to driving for avoiding the collision. The centering steering control may be executed when the driving state detector 130 detects that the driver is in the distracted driving state or when the collision margin value satisfies the operating condition of the steering control. The above-described gradual deceleration control and centering steering control may be executed separately or may be executed simultaneously at the same timing (e.g., in an alert control step).

When the collision possibility determiner 120 determines that there is a possibility of a collision between the host vehicle M and an obstacle, the collision avoidance steering controller 144B generates a target trajectory (an avoidance target trajectory) for avoiding the collision and executes steering control related to avoidance steering assistance so that the host vehicle M travels along the generated target trajectory. For example, when avoidance within the travel lane of the host vehicle Mis possible, the collision avoidance steering controller 144B performs steering control for movement in a direction in which the host vehicle M does not come into collision with the obstacle within a range that does not depart from the same lane, independently of the driver's steering operation. The collision avoidance steering controller 144B may perform steering control of the host vehicle M so that the behavior of the host vehicle M subsequent to the avoidance operation is stable after the host vehicle M performs an obstacle avoidance operation by straddling a marking for dividing the traveling lane due to the driver's steering operation. In the steering control of the collision avoidance steering controller 144B, for example, feedforward control or feedback control is performed as needed on the basis of the avoidance target trajectory and the position of the host vehicle M to adjust the steering angle of the host vehicle M. The steering control to be executed by the collision avoidance steering controller 144B may be executed, for example, after the centering steering control, or may be executed when the collision margin value satisfies the operating condition of the steering control.

The lane-keeping steering controller 144C executes steering control related to lane-keeping steering assistance, for example, as lane-keeping assistance system (LKAS) control (lane-keeping control) so that the host vehicle M is kept within the travel lane (in other words, so that departure of the host vehicle M from the travel lane is suppressed). For example, the lane-keeping steering controller 144C controls the steering device 220 so that the host vehicle M does not depart from the travel lane recognized by the recognizer 110, thereby assisting the driver in steering. In this case, the lane-keeping steering controller 144C generates a target trajectory (a lane-keeping target trajectory) so that the host vehicle M travels in the center of the travel lane, and executes steering control of the host vehicle M so that the host vehicle M travels along the generated target trajectory. In the steering control of the lane-keeping steering controller 144C, for example, feedforward control or feedback control is performed as needed on the basis of the lane-keeping target trajectory and the position of the host vehicle M to adjust the steering angle of the host vehicle M. The lane-keeping steering controller 144C may execute similar control even in the case of road departure mitigation (RDM) control instead of the LKAS control.

The steering override controller 144D determines whether or not to perform override control according to the driver's operation during the execution of steering control (centering steering control, collision avoidance steering control, or lane-keeping steering control). The driver's operation used for the override determination during steering control is the steering operation of the steering wheel 82. For example, the steering override controller 144D determines to perform override control when a steering input torque due to the driver's steering operation becomes equal to or greater than an override threshold value. When it is determined to perform the override control, the steering override controller 144D stops the steering control being executed. In this way, it is possible to execute the more appropriate override control (control for switching to manual driving by the driver) for the steering control by determining the driver's intention according to the steering operation.

The vehicle controller 140 may perform control by performing a switching process for driving assistance to be executed within the above-described driving assistance control processes by turning on or off a changeover switch provided in the HMI 30. For example, when the changeover switch related to the lane-keeping steering assistance is turned off, the vehicle controller 140 does not execute control in the lane-keeping steering controller 144C. Thereby, driving assistance according to the driver's intention can be implemented.

### [Regarding Vehicle Control Related to Collision Avoidance]

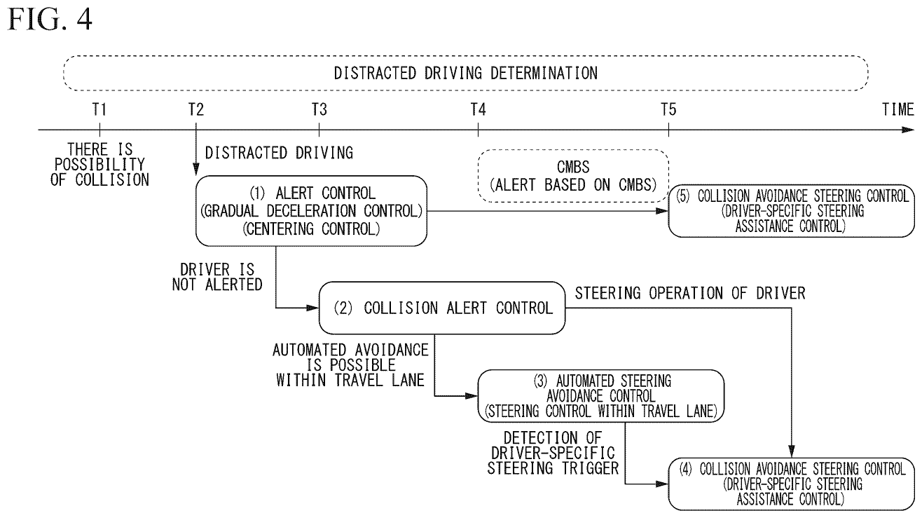

Next, the content of vehicle control related to collision avoidance in the embodiment will be specifically described. In the following description, it is assumed that the obstacle is another vehicle (a preceding vehicle) traveling in front of the host vehicle M. FIG. 4 is an explanatory diagram of the content of vehicle control related to collision avoidance. In the example of FIG. 4, the content of the vehicle control of a case where it is determined that there is a possibility of a collision on the basis of the time to collision TTC is shown. In the example of FIG. 4, time T1 is earliest and times T2, T3, T4, and T5 are later in that order. In the example of FIG. 4, it is assumed that the driving state detector 130 continues to determine whether or not the vehicle is in a distracted driving state in a predetermined period from a step before time T1.

First, it is assumed that the collision possibility determiner 120 determines that there is a possibility of a collision between the host vehicle M and another vehicle at time T1. When it is determined that there is a possibility of a collision, the vehicle controller 140 performs alert control ((1) in FIG. 4) for alerting the driver to the surroundings (particularly a travel direction) on the basis of the time to collision TTC and a distracted driving determination result.

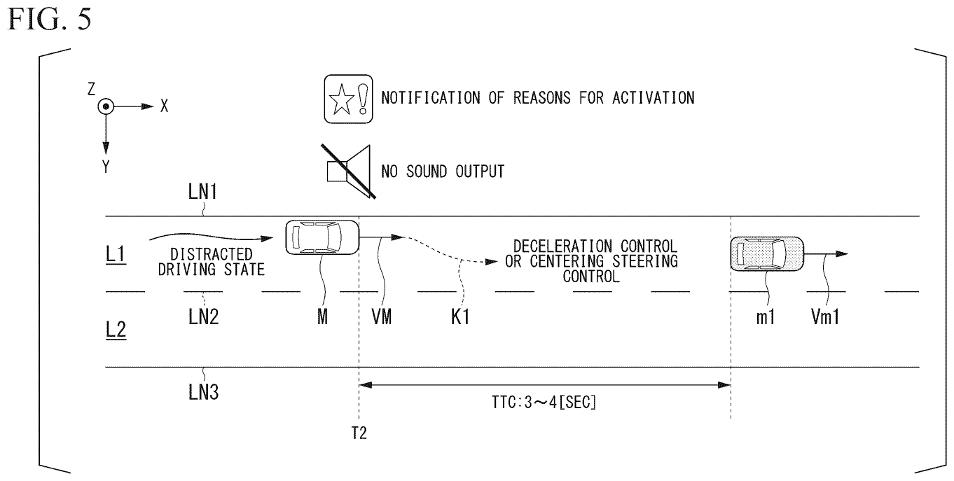

FIG. 5 is an explanatory diagram of the content of the alert control. In the example of FIG. 5, two lanes L1 and L2 where traveling is possible in the same direction (an X-axis direction in FIG. 5) are shown. The lane L1 is divided by road markings LN1 and LN2, and the lane L2 is divided by road markings LN2 and LN3. In the example of FIG. 5, the host vehicle M travels in the lane L1 at a speed VM, and another vehicle m1 is in front of the host vehicle M and travels in the lane L1 at a speed Vm1.

In the example of FIG. 5, the vehicle controller 140 performs alert control when the time to collision TTC based on relative positions and relative speeds of the host vehicle M and the other vehicle m1 becomes less than a first predetermined time at time T2 and the driver is determined to be in the distracted driving state. Time T2 is, for example, the time when the time to collision TTC becomes about 3 to 4 sec.

The alert control includes, for example, at least one of gradual deceleration control and centering steering control. The gradual deceleration control executed in the alert control is control in a first deceleration state. The gradual deceleration controller 142A sets the target deceleration (the first target deceleration) so that a load (longitudinal G) of first upper limit deceleration (about 0.1 [G]) is applied to the driver in the travel direction (the longitudinal direction). In the alert control (the first deceleration state), the gradual deceleration controller 142A may first perform the gradual deceleration control at a first deceleration degree (e.g., vertical G of 0.05 [G]), and then perform the deceleration control at a second deceleration degree (e.g., vertical G of 0.1 [G]) that is greater than the first deceleration degree. By controlling the deceleration degree so that the deceleration degree increases step by step in this way, it is possible to reduce the load on the occupant such as the driver when the gradual deceleration control starts to be executed and to prevent the occupant from being surprised by the gradual deceleration control.

In the alert control shown in FIG. 5, the centering steering controller 144A performs centering steering control for steering the host vehicle M so that a reference point such as a center of gravity or a center of the host vehicle M is positioned in the center of the travel lane (the lane L1) on the basis of a recognition result of the recognizer 110, map information, or the like. In the example of FIG. 5, the vehicle controller 140 generates a future target trajectory K1 of the host vehicle M corresponding to the gradual deceleration control and the centering steering control, and controls the steering and speed of the host vehicle M so that the host vehicle M travels along the generated target trajectory K1.

At time T2, the HMI controller 150 may generate an image including information indicating the reasons for the activation of the alert control (the gradual deceleration control or the centering steering control) for the driver and may provide a notification to the driver by displaying the generated image on the display 32. The image may include information for alerting the driver. Here, in this case, audio output may not be performed. Thereby, it is possible to easily notify the driver that the host vehicle M is approaching the other vehicle m1 to prompt the driver to pay attention to the other vehicle m1 and to prompt the driver to perform an early avoidance operation.

Returning to FIG. 4, when the time at which the time to collision TTC becomes less than the second predetermined time (second predetermined time<first predetermined time) becomes time T3 and it is determined that the driver is in the distracted driving state in a state in which the driver does not respond to the alert (or override control) even if the above-described alert control is performed, the collision alert control ((2) in FIG. 4) is performed. Whether or not the driver responds to the alert is determined on the basis of, for example, a camera image captured by the driver monitor camera 70. Time T3 is, for example, the time when the time to collision TTC becomes about 2 sec.

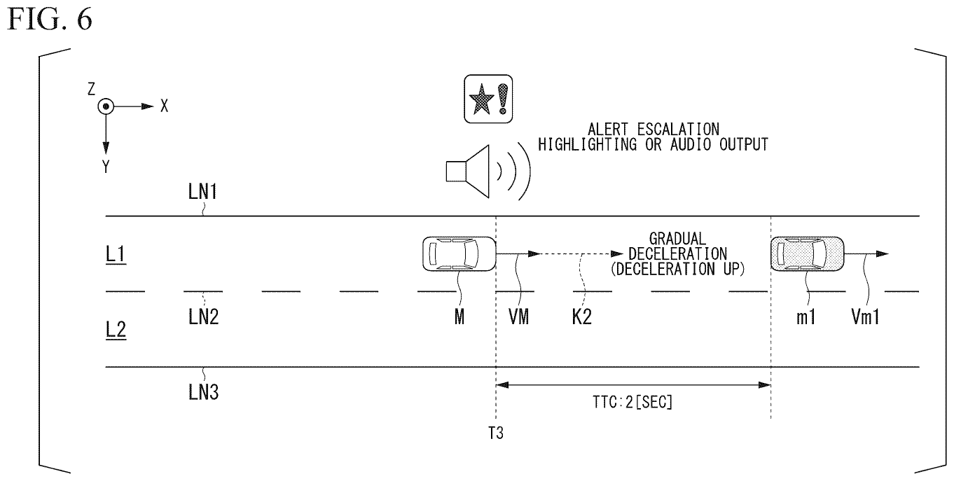

FIG. 6 is an explanatory diagram of the content of the collision alert control. In FIG. 6, a scene in which the time to collision TTC becomes 2 sec in a situation in which the driver is not operating the accelerator from the situation shown in FIG. 5 is shown. In a collision alert control step, the gradual deceleration controller 142A sets target deceleration (second target deceleration), executes gradual deceleration control according to the set second target deceleration, generates a target trajectory K2, and performs control so that the host vehicle M travels along the generated target trajectory K2. The gradual deceleration control executed in the collision alert control is control in the second deceleration state. In the second deceleration state, the gradual deceleration controller 142A sets target deceleration (second target deceleration) so that a load (longitudinal G) greater than at the first upper limit deceleration is applied to the driver in the travel direction (the longitudinal direction) at the second upper limit deceleration (approximately 0.2 [G]) or less. Thereby, it is possible to allow the driver to more clearly perceive that the host vehicle M is approaching the other vehicle m1. In this way, because the deceleration control is performed while the deceleration increases as necessary, more time can be created to make the driver aware of the other vehicle m1 and the driver can perform driving for avoiding the collision with the other vehicle m1 with sufficient time.

During the collision alert control, in addition to (or instead of) the gradual deceleration control, the centering steering control of the centering steering controller 144A may be executed. During the collision alert control, the HMI controller 150 may execute control (alert escalation control) for highlighting an image of alert information displayed on the display 32 or causing the speaker 34 to output an alert. Thereby, the driver can be notified of an image or sound that there is a high possibility of a collision while deceleration is further performed and the driver can be alerted more clearly or prompted to perform collision avoidance control. The above-described alert control and collision alert control are control that is executed as “alert control.”

Returning to FIG. 4, after the execution of the collision alert control, the vehicle controller 140 executes the automated steering avoidance control at time T4 when it is determined that automated avoidance is possible within the travel lane on the basis of the surrounding situation recognized by the recognizer 110 ((3) in FIG. 4). Time T4 is the time when the host vehicle M is closer to the other vehicle m1 compared to time T3 (e.g., when the time to collision TTC is less than approximately 2 sec).

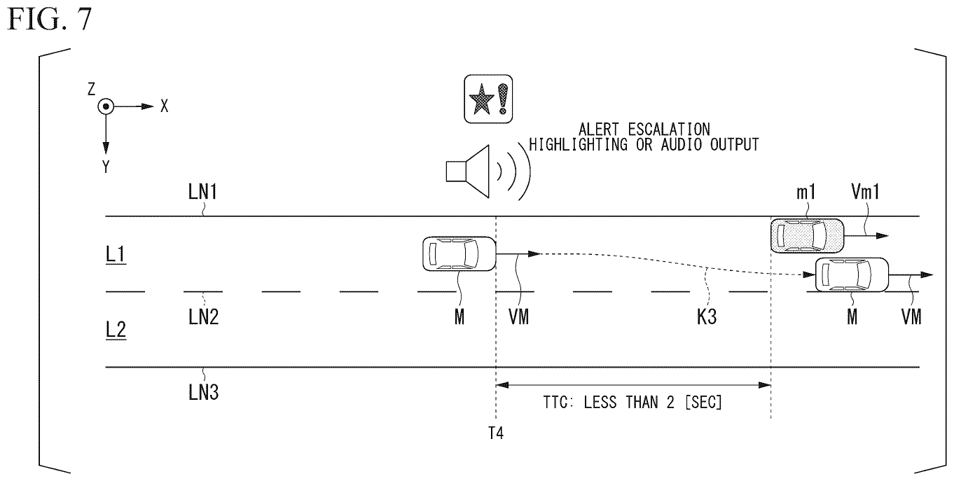

FIG. 7 is an explanatory diagram of the content of the automated steering avoidance control. In the example of FIG. 7, the control is performed when the driver does not perform a predetermined accelerator operation after the execution of the collision alert control. In this case, the collision avoidance steering controller 144B recognizes an area of the travel lane (lane L1) and a position of the other vehicle m1 on the basis of the recognition result of the recognizer 110, generates an avoidance target trajectory K3 for traveling through an avoidance space when there is the avoidance space in the travel lane, and executes steering control so that the host vehicle M travels along the generated avoidance target trajectory K3. In this case, the vehicle controller 140 may execute acceleration/deceleration control as necessary. During the automated steering avoidance control, the HMI controller 150 may continue to execute the above-described alert escalation control. Thereby, when steering avoidance is possible with highly safe control, more appropriate vehicle control can be implemented by executing automated steering control.

In the vehicle controller 140, control may be executed in parallel with the CMBS control of the collision avoidance braking controller 142B at the timing of time T4. When the CMBS control is executed, the above-described automated steering avoidance control and the driver-specific steering assistance control to be described below may not be executed. In this case, the HMI controller 150 may output an alert (an image or sound) related to the CMBS control.

Returning to FIG. 4, at time T5 when the driver operates the steering wheel 82 (detects the driver-specific steering trigger) and performs a steering operation in a direction for avoiding the other vehicle m1, the collision avoidance steering controller 144B executes collision avoidance steering control (driver-specific steering assistance (an example of avoidance steering assistance)) so that the departure from the adjacent lane (the lane L2) adjacent to the travel lane (the lane L1) is further avoided ((4) in FIG. 4). The driver-specific steering trigger is, for example, when the driver's steering input torque for avoiding another vehicle m1 is equal to or greater than a predetermined value.

The predetermined value here is a value less than the override threshold value. The driver-specific steering assistance control may be executed after the automated steering avoidance control or may be executed after the collision alert control (at the timing of time T4 without the automated steering avoidance control being performed).

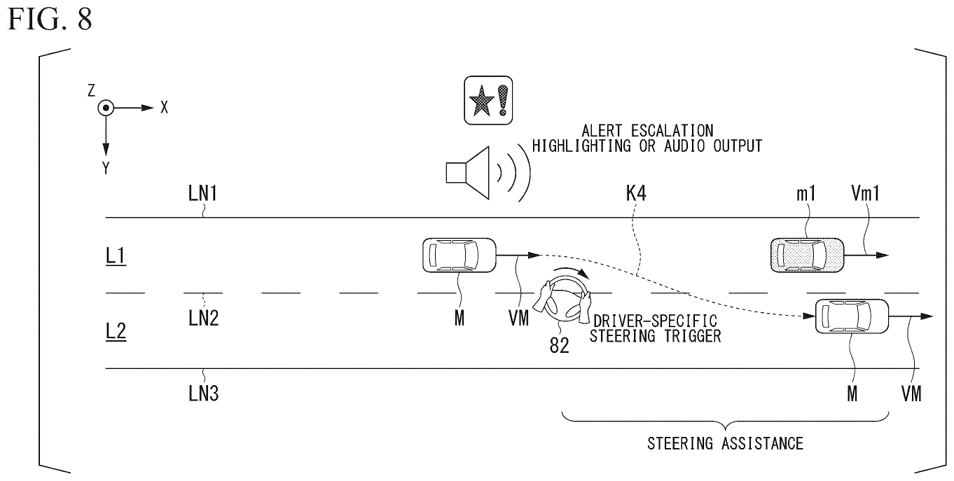

FIG. 8 is an explanatory diagram of the steering control after the driver-specific steering trigger. In the example of FIG. 8, when the collision of the host vehicle M with the other vehicle m1 is imminent and the driver-specific steering trigger is detected, the collision avoidance steering controller 144B performs steering control of the host vehicle M so that the host vehicle M is allowed to move from the lane L1 to the adjacent lane L2 and further the host vehicle M does not depart from the adjacent lane L2. In this case, the collision avoidance steering controller 144B generates an avoidance target trajectory K4 for making a lane change to the lane L2 and controls at least the steering of the host vehicle M so that the position of the host vehicle M approaches the avoidance target trajectory K4 according to the driver's steering operation, thereby providing the avoidance steering assistance. In this case, instead of (or in addition to) the steering control, the collision avoidance steering controller 144B may perform control so that a reaction force is applied to the steering wheel 82 with respect to the driver's steering operation and an increase in the steering input torque amount is suppressed. During the driver-specific steering assistance control, the HMI controller 150 may continue to execute the above-described alert escalation control. Thereby, more appropriate vehicle control can be implemented even if emergency avoidance steering is performed by the driver's steering operation.

Returning to FIG. 4, when the time to collision TTC approaches a limit value after the alert control shown in FIG. 4 (1) and the driver performs a steering operation, the vehicle controller 140 provides driver-specific steering assistance so that the departure from the adjacent lane is further avoided, as in control of (4) of FIG. 4 ((5) of FIG. 4). In this case, the HMI controller 150 may perform notification control for a notification, an alert, or the like indicating that the driver-specific steering assistance control is operating. The above-described collision avoidance braking control and collision avoidance steering control are control to be executed as “avoidance control.”

### [Regarding Suppression of Steering Control]

For example, in the above-described driver-specific steering assistance control shown in (4) and (5) of FIG. 4, during driver-specific steering assistance (and in a case where override control is not being executed), if the steering controller 144 (the vehicle system) executes steering (steering angle) control for making the host vehicle M closer to the avoidance target trajectory K4 or executes control for applying a reaction force to the steering wheel 82 with respect to the driver's steering operation, the driver who performs a steering operation with the intention of causing the host vehicle M to travel along a trajectory other than the avoidance target trajectory K4 is likely to feel uncomfortable. Therefore, in the embodiment, when the driver performs a steering operation during the driver-specific steering assistance, the steering controller 144 suppresses steering control for the avoidance target trajectory.

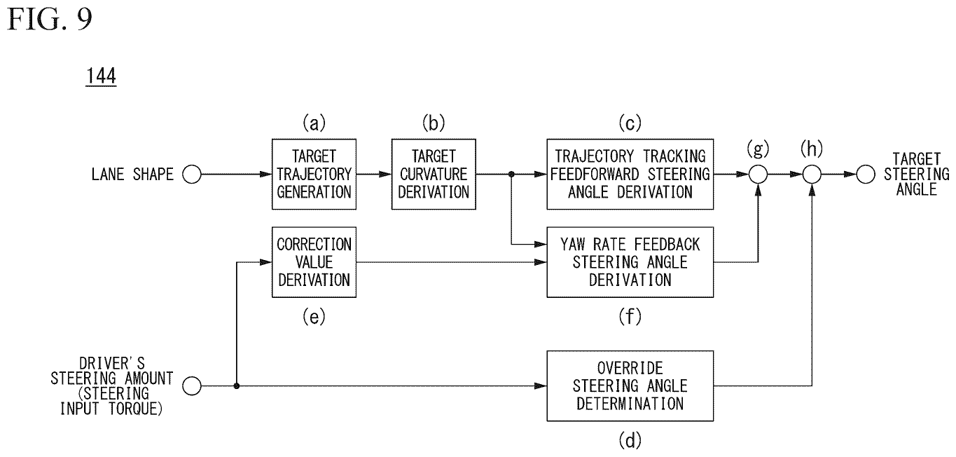

FIG. 9 is an explanatory diagram of the steering control process executed by the steering controller 144. In FIG. 9, as an example of the process executed by the steering controller 144, a part for deriving the target steering angle is shown using a lane shape (including a shape of the lane in which the host vehicle Mis traveling and a shape of the adjacent lane) around the host vehicle M recognized by the recognizer 110 and the driver's steering amount (steering input torque) detected by the SW sensor 82A as inputs. After the target steering angle is determined, the steering controller 144 adjusts the steering angle of the host vehicle M to approach the target steering angle and causes the host vehicle M to travel. Hereinafter, the steering control process during driver-specific steering assistance and the steering control process during lane-keeping steering assistance are included and described.

In the example of FIG. 9, the steering controller 144 generates a target trajectory on the basis of the lane shape around the host vehicle M ((a) in FIG. 9). For example, an avoidance target trajectory is generated when the collision avoidance steering controller 144B performs the collision avoidance steering control and a lane-keeping target trajectory is generated when the lane-keeping steering controller 144C performs the lane-keeping steering control. Subsequently, the steering controller 144 derives curvature (target curvature) required for the host vehicle M to travel along the target trajectory on the basis of the generated target trajectory and the position information of the host vehicle M detected by the vehicle sensor 40, or the like ((b) in FIG. 9) and derives a future steering angle (trajectory tracking feedforward steering angle) required for the host vehicle M to travel with the derived curvature ((c) in FIG. 9).

The steering controller 144 (the steering override controller 144D) determines, for example, whether the steering angle corresponding to the driver's steering amount is equal to or greater than a predetermined steering angle (an example of an override threshold value) for performing override control ((d) in FIG. 9). For example, when the steering angle corresponding to the driver's steering amount is equal to or greater than the predetermined steering angle, it is determined to perform the override control.

The steering controller 144 derives a correction value according to the driver's steering amount ((e) in FIG. 9). The correction value is a value that cancels (reduces) the yaw rate feedback steering angle to be described below. The correction value is derived, for example, on the basis of the driver's steering amount and the speed VM of the host vehicle M. An example of the derivation will be described below.

Subsequently, the steering controller 144 performs feedback control for the yaw rate of the host vehicle M on the basis of a target yaw rate obtained from the target curvature (e.g., target yaw rate=target curvature×speed VM of the host vehicle M) and derives a steering angle (yaw rate feedback steering angle) corresponding to the yaw rate ((f) in FIG. 9). The process of (f) in FIG. 9 is a process for deriving a steering angle for returning the position of the host vehicle M, which has moved according to the driver's steering amount, to the target trajectory. In this process, the steering angle amount for returning to the target trajectory is adjusted using the correction value.

Subsequently, the steering controller 144 derives a target steering angle during steering control (e.g., during avoidance steering assistance or lane-keeping steering assistance) on the basis of the trajectory tracking feedforward steering angle derived in the process of (c) in FIG. 9 and the yaw rate feedback steering angle derived in the process of (f) in FIG. 9 ((g) in FIG. 9). Thereby, a target steering angle based on feedforward control and feedback control is derived. When it is determined to perform override control in the process of override steering angle determination of (d) in FIG. 9, the steering controller 144 may set the steering angle for the driver's steering amount as the target steering angle instead of the derived target steering angle ((h) in FIG. 9).

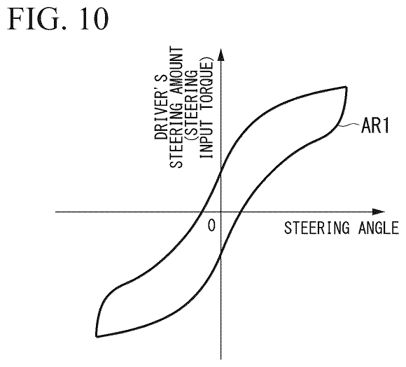

Here, the derivation of the correction value according to the driver's steering amount (steering input torque) will be described. FIG. 10 is a diagram showing the relationship between the driver's steering amount and the steering angle. In the example of FIG. 10, the vertical axis represents the driver's steering amount (steering input torque) and the horizontal axis represents the steering angle. In the derivation of the correction value, the steering angle for tracking the trajectory is set as the reference (zero) and the correction value is derived so that the steering angle provided according to the driver's steering amount falls within an area AR1 shown in FIG. 10. The steering angle is proportional to the curvature (the curvature required for the host vehicle M to travel).

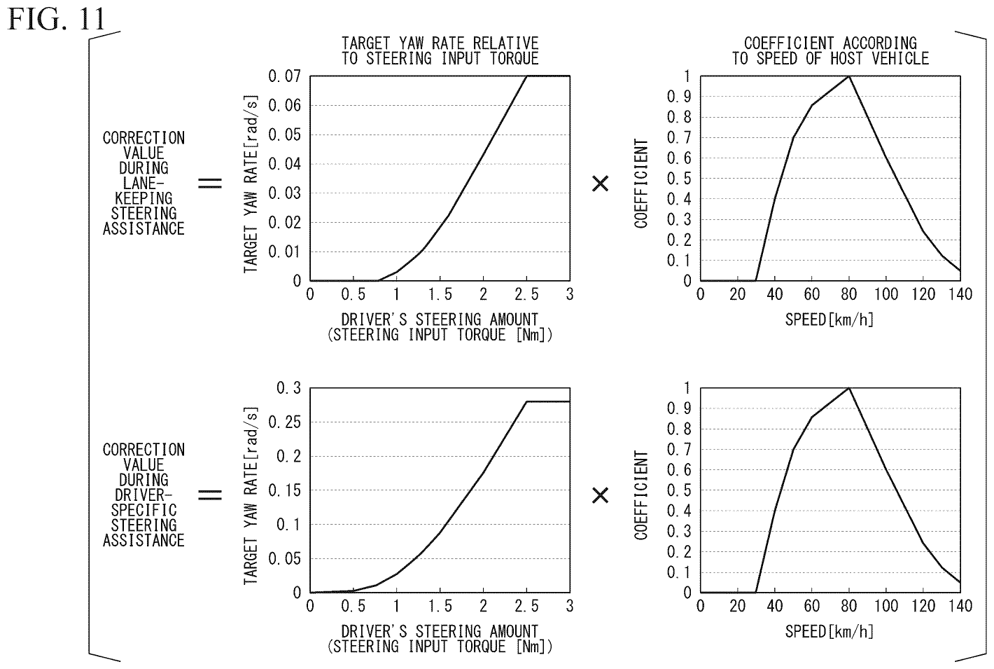

FIG. 11 is an explanatory diagram of the derivation of the correction value. In FIG. 11, an example of derivation of a correction value (an example of a first correction value) during driver-specific steering assistance and an example of derivation of a correction value (an example of a second correction value) during lane-keeping steering assistance such as LKAS or RDM are shown. Each correction value is calculated, for example, by multiplying the target yaw rate [rad/s] for the driver's steering amount (steering input torque [Nm]) by a coefficient (ratio) according to the speed VM [km/h] of the host vehicle M.

Steering control related to the lane-keeping steering assistance is a function that should be actively supported by the vehicle system side. Therefore, at least one of the increased degree or upper limit value of the target yaw rate according to the increase in the driver's steering amount is adjusted so that the value of the target yaw rate relative to the driver's steering amount is smaller (smaller than when the driver-specific steering assistance is performed). On the other hand, the steering control related to the driver-specific steering assistance is positioning control for supporting the driver's steering operation that requires a large steering amount. Therefore, at least one of the increased degree or upper limit value of the target yaw rate according to the increase in the driver's steering amount is adjusted so that the value of the target yaw rate relative to the driver's steering amount is larger (larger than when the lane-keeping steering assistance is performed). In the example of FIG. 11, both the increased degree and the upper limit value of the target yaw rate relative to the increase in the driver's steering amount are adjusted to be greater than when the lane-keeping steering assistance is performed. The value of the target yaw rate relative to the driver's steering amount may be adjusted to be smaller during lane-keeping steering assistance and larger during driver-specific steering assistance with respect to a predetermined reference value.

The coefficient according to the speed VM of the host vehicle M corresponds to, for example, the adjustment of the behavior of the host vehicle M according to the speed normalized by the speed VM (e.g., 80 [km/h]). In other words, a coefficient is set on the basis of the behavior of the host vehicle M for each speed. For example, this coefficient is adjusted so that the coefficient increases until the speed VM of the host vehicle M reaches a predetermined speed and further decreases after the speed VM of the host vehicle M exceeds the predetermined speed. In the example of FIG. 11, when the speed VM is between 30 and 80 [km/h], the coefficient increases as the speed VM increases, and when the speed VM exceeds 80 [km/h] and enters a high-speed region, the coefficient decreases as the speed VM increases to suppress the excessively larger behavior of the vehicle. By using the coefficient according to the speed VM of the host vehicle M in deriving the correction value, the excessive behavior of the vehicle in the high-speed region can be suppressed and an appropriate correction value according to the situation of the host vehicle M can be derived.

In this way, in the feedback control of the steering angle of the host vehicle M (the derivation of the yaw rate feedback steering angle), it is possible to implement more appropriate driving control in accordance with the situation of the host vehicle M by using different correction values during lane-keeping steering assistance and during driver-specific steering assistance. For example, because a value that cancels the yaw rate feedback steering angle can be made larger by making the correction value during the driver-specific steering assistance (a first correction value) larger than the correction value during the lane-keeping steering assistance (a second correction value), control for attempting to return the host vehicle M to the target trajectory on the system side can be more effectively suppressed. Therefore, during the driver-specific steering assistance, the driver's steering operation is more likely to be reflected in the target steering angle. Thereby, because control for prioritizing the driver's steering operation is performed during the collision avoidance driving based on the driver's steering operation and the driver's steering can be appropriately reflected in the vehicle's behavior, it is possible to reduce the driver's discomfort and implement safer driving. By adjusting the correction value with a coefficient according to the speed VM, it is possible to suppress the inappropriately excessive behavior of the vehicle due to the excessively large behavior of the vehicle according to the driver's steering operation in the high-speed region.

### [Processing Flow]

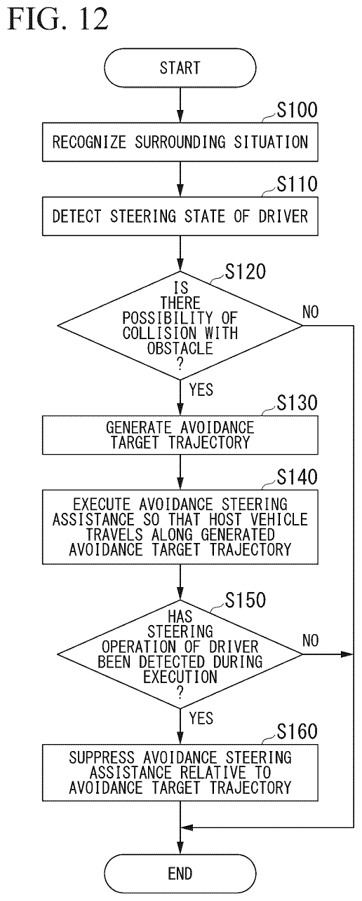

Next, an example of the process executed by the driving assistance device 100 in the embodiment will be described. FIG. 12 is a flowchart showing an example of the process executed by the driving assistance device 100 in the embodiment. In the example of FIG. 12, a vehicle control process related to avoidance steering control within the process executed by the driving assistance device 100 will be mainly described. In addition to the process shown in FIG. 12, the driving assistance device 100 may execute a collision possibility determination process, a distracted driving determination process, an alert control process, a collision alert control process, an automated steering avoidance control process, and the like, as shown in FIG. 4, in accordance with each of the execution conditions described above.

In the example of FIG. 12, the recognizer 110 recognizes a surrounding situation of the host vehicle M (step S100). Subsequently, the driving state detector 130 detects a steering state of the driver (step S110). Subsequently, the collision possibility determiner 120 determines whether or not there is a possibility that the host vehicle M will come into collision with an obstacle (step S120). When it is determined that there is a possibility of a collision with an obstacle, the collision avoidance steering controller 144B generates an avoidance target trajectory for the host vehicle M to avoid the collision with the obstacle (step S130) and provides avoidance steering assistance so that the host vehicle M travels along the generated avoidance target trajectory (step S140).

Subsequently, the collision avoidance steering controller 144B determines whether or not the driver's steering operation has been detected during the execution of the avoidance steering assistance (step S150). When it is determined that the driver's steering has been detected during the execution, the collision avoidance steering controller 144B suppresses the avoidance steering assistance for the avoidance target trajectory using the above-described correction value and the like (step S160). Thereby, the process of the present flowchart ends. When it is determined that there is no possibility of a collision with an obstacle in the processing of step S120 or when it is determined that the driver's steering operation has not been detected during the provision of the avoidance steering assistance in the processing of step S150, the process of the present flowchart ends.

As described above, according to the embodiment, the vehicle control program causes a computer to recognize a surrounding situation of a vehicle; detect a steering state of an occupant of the vehicle; execute avoidance steering assistance so that the vehicle travels along an avoidance target trajectory for avoiding an obstacle when it is determined that the vehicle is likely to come into collision with the obstacle on the basis of the recognized surrounding situation of the vehicle; and suppress the avoidance steering assistance for the avoidance target trajectory when a steering operation of the occupant has been detected while the avoidance steering assistance is being executed, such that it is possible to appropriately reflect the steering of the occupant in the vehicle's behavior in accordance with a situation of the vehicle.

Specifically, according to the embodiment, avoidance steering assistance is provided for the host vehicle M when it is determined that there is a possibility of a collision between the host vehicle M and an obstacle and steering control of the vehicle system for the avoidance target trajectory is suppressed when there is a steering operation by the driver during the avoidance steering assistance, such that control for attempting to return the driver's steering in a direction away from the target trajectory to the target trajectory can be suppressed. Therefore, the driver's steering can be reflected in the vehicle's behavior and the discomfort felt by the driver in response to the steering operation can be reduced.

According to the embodiment, a correction value according to the driver's steering amount is derived for feedback control of the avoidance target trajectory, and steering control for the target trajectory is performed based on the derived correction value, thereby suppressing control for attempting to return the host vehicle M to the target trajectory by feedback. According to the embodiment, the correction value according to the driver's steering amount during avoidance steering assistance is made larger than the correction value during assistance other than avoidance steering assistance (e.g., during lane-keeping steering assistance), such that the driver's steering can be appropriately reflected in the vehicle's behavior and therefore the discomfort felt by the driver can be reduced and safer driving can be implemented. By adjusting the correction value with a coefficient according to the speed VM of the host vehicle M, it is possible to suppress the inappropriately excessive behavior of the vehicle due to the excessively large behavior of the vehicle according to the driver's operation in the high-speed region.

### Modified Example

In the above-described embodiment, the driver-specific steering assistance control may be collision avoidance steering control performed within a travel lane (a lane L1) in addition to (or instead of) executing steering control so that the host vehicle M does not depart from a lane L2 when the host vehicle M moves from the travel lane (the lane L1) to an adjacent lane (the lane L2) as shown in FIG. 8. In this case, the driver-specific steering assistance control allows an avoidance target trajectory to be generated to avoid the collision with an obstacle without the departure from the travel lane and avoidance steering assistance is provided so that the host vehicle M travels along the generated avoidance target trajectory. During this steering control, when a steering operation of the driver has been detected, the avoidance steering assistance is suppressed.

In the embodiment, in addition to (or instead of) the driver-specific steering assistance control, the steering controller 144 may suppress the automated steering avoidance control when a steering operation of the driver has been detected (and the override control is not executed), for example, during the automated steering avoidance control as shown in FIG. 7.

Although the collision avoidance steering control (driver-specific steering assistance control) after the alert control (gradual deceleration control or centering control) is executed has been described in the above-described embodiment, the present invention may also be applied to a case where the driver-specific steering assistance control is executed in a state in which the alert control is not executed.

The numerical values shown in the above-described embodiment are merely examples and may be adjusted as appropriate in accordance with a road situation (a shape, the number of lanes, a road type, and the like), the driver's driving situation (a degree of distractedness), a vehicle situation (a speed, a vehicle type, a shape, and the number of occupants), and the like.

The embodiment described above can be represented as follows.

A vehicle control device including:
a storage medium storing computer-readable instructions; and
a processor connected to the storage medium, the processor executing the computer-readable instructions to:
recognize a surrounding situation of a vehicle;
detect a steering state of an occupant;
execute avoidance steering assistance so that the vehicle travels along an avoidance target trajectory for avoiding an obstacle when it is determined that the vehicle is likely to come into collision with the obstacle on the basis of the recognized surrounding situation of the vehicle; and
suppress the avoidance steering assistance for the avoidance target trajectory when a steering operation of the occupant has been detected while the avoidance steering assistance is being executed.

Although modes for carrying out the present invention have been described above using embodiments, the present invention is not limited to the embodiments and various modifications and substitutions can also be made without departing from the scope and spirit of the present invention.

What is claimed is:

1. A vehicle control method comprising:
recognizing, by a computer, a surrounding situation of a vehicle;
detecting, by the computer, a steering state of an occupant;
executing, by the computer, avoidance steering assistance so that the vehicle travels along an avoidance target trajectory for avoiding an obstacle when it is determined that the vehicle is likely to come into collision with the obstacle on the basis of the recognized surrounding situation of the vehicle; and
suppressing, by the computer, the avoidance steering assistance for the avoidance target trajectory when a steering operation of the occupant has been detected while the avoidance steering assistance is being executed.

2. The vehicle control method according to claim 1,
wherein feedback control for a steering angle of the vehicle is executed so that the vehicle travels along the avoidance target trajectory on the basis of the avoidance target trajectory and a position of the vehicle, and
wherein the avoidance steering assistance during the execution is suppressed by deriving a first correction value according to a steering amount included in the detected steering state of the occupant and adjusting the steering angle in accordance with the derived first correction value in the execution of the feedback control.

3. The vehicle control method according to claim 2,
wherein lane-keeping steering assistance for performing the feedback control for the steering angle of the vehicle is provided so that the vehicle travels along a lane-keeping target trajectory for suppressing a departure of the vehicle from a travel lane on the basis of the lane-keeping target trajectory and a position of the vehicle,
wherein the lane-keeping steering assistance during the execution is suppressed by deriving a second correction value according to a steering amount included in the detected steering state of the occupant and adjusting the steering angle in accordance with the derived second correction value in the execution of the feedback control, and
wherein the first correction value is larger than the second correction value.

4. The vehicle control method according to claim 3,
wherein the first correction value and the second correction value are derived on the basis of the steering amount and a speed of the vehicle, and
wherein an adjustment is made so that the speed of the vehicle increases to a predetermined speed in accordance with an increase in the speed and decreases after exceeding the predetermined speed.

5. The vehicle control method according to claim 1, wherein the avoidance steering assistance is provided to generate the avoidance target trajectory so that the vehicle does not depart from an adjacent lane after the vehicle moves from a current travel lane to the adjacent lane so that a collision with the obstacle is avoided.

6. A vehicle control device comprising:
a recognizer configured to recognize a surrounding situation of a vehicle;
a steering state detector configured to detect a steering state of an occupant; and
a steering controller configured to execute avoidance steering assistance so that the vehicle travels along an avoidance target trajectory for avoiding an obstacle when it is determined that the vehicle is likely to come into collision with the obstacle on the basis of the surrounding situation of the vehicle recognized by the recognizer,
wherein the steering controller suppresses the avoidance steering assistance for the avoidance target trajectory when a steering operation of the occupant has been detected while the avoidance steering assistance is being executed.

7. A computer-readable non-transitory storing medium storing a vehicle control program for causing a computer to
recognize a surrounding situation of a vehicle;
detect a steering state of an occupant of the vehicle;
execute avoidance steering assistance so that the vehicle travels along an avoidance target trajectory for avoiding an obstacle when it is determined that the vehicle is likely to come into collision with the obstacle on the basis of the recognized surrounding situation of the vehicle; and
suppress the avoidance steering assistance for the avoidance target trajectory when a steering operation of the occupant has been detected while the avoidance steering assistance is being executed.
